(19) United States
(12) Patent Application Publication
(10) Pub. No.: US 2020/0305454 A1
(43) Pub. Date: Oct. 1, 2020

(54) CHILLED DAIRY DESSERT WITH SOLID PIECES

(71) Applicant: NESTEC S.A., Vevey (CH)

(72) Inventors: Tanja Dahlke, Cormeilles (FR); Jean Moreau, Manerbe (FR); Murieie Rey-Garcia, Falaise (FR)

(21) Appl. No.: 16/308,882

(22) PCT Filed: Jun. 13, 2017
(86) PCT No.: PCT/EP2017/064465

§ 371 Date: Dec. 11, 2018

(30) Foreign Application Priority Data
Jun. 13, 2016 (EP) 16174193.9

(51) Int. Cl. A23C 9/156; A23C 9/152; A23C 9/133

(52) U.S. Cl. CPC A23C 9/156; A23C 9/1524; A23C 2270/05; A23C 2210/30; A23C 9/133

(57) ABSTRACT

The invention relates to a chilled dairy dessert which exhibits several textures and flavours, and contains a mousse with solid pieces and threads of sauce. The invention also relates to a process for producing a chilled dairy dessert containing solid pieces and a sauce.

### TECHNICAL FIELD

The invention relates to a chilled dairy dessert which exhibits several textures and flavours, in particular containing solid pieces and a sauce. The invention also relates to a process and a device for producing a chilled dairy dessert containing solid pieces and a sauce.

### BACKGROUND OF THE INVENTION

Mousses (i.e. aerated food compositions) based on dairy products (i.e. milk food products) are well known in the art. Mousses are obtained by whipping air or gas into a dairy base, to obtain a foamed product.

Their aerated texture is highly appreciated by the consumers. However, contrarily to frozen products, chilled mousses containing solid pieces and having a shelf-life of at least 28 days are difficult to obtain, because their structure is not stable along time, and are not stabilized by freezing. Stability may be impacted, for instance, by the quality of the inclusions, in particular with respect to fruit or nut pieces, or by interactions between the different phases, which may cause syneresis and collapse of the mousse.

In particular, when the chilled dairy dessert is presented in a large container (300-400 ml), mousse stability and/or syneresis issues are enhanced.

Also, in order that the consumer perceives the different textures, in particular the crunchiness of the solid pieces in contrast to the softness and/or the lightness of the mousse, it is necessary to control different parameters, such as, for instance, the size and amount of solid pieces in the composition, or the viscosity of the mousse, for example.

EP1980153 discloses a chilled product based on a cream or a mousse and on chocolate which is crunchy in nature after cooling, in the form of a succession of superimposed layers of dairy cream or mousse and thin layers of sheets of chocolate, where the molten chocolate layer is trapped between two layers of milk product.

EP0651692 relates to a refrigerated product based on at least one mousse and containing pieces of chocolates, having a storage life of 5 to 6 weeks in the refrigerator. According to this document, a product with longer storage life can be obtained because the chocolate used has been sterilized, the mousse being treated UHT before overrunning. This treatment is only possible because of the low sugar content in the chocolate.

EP2177109 relates to a method for producing a composite dairy product by co-filling viscous components and obtaining a spiral or spiral-like product aspect. In this method, the filing nozzle is fixed. The product exhibits two different textures only: that of a dairy component such as a yoghurt or a fresh cheese, and that of a sauce or a fruit puree.

FR2876877 discloses a chilled multilayer dairy product containing a layer of chocolate which has a storage lifetime of 12 days to 6 weeks at 0° C. to 10° C. This product is obtained by directly injecting liquid chocolate in the container, where chocolate solidifies when in contact to the cold dairy product and does not need later breaking into pieces.

None of these documents addresses the problem of multi-texture components within a chilled dairy dessert, nor the stability issues associated therewith.

It is therefore an object of the invention to provide an aerated chilled dairy dessert containing solid pieces and a sauce, having a long shelf stability, where the solid pieces remain distributed throughout the mousse matrix, resulting in the co-existence of different textures, for instance three different textures.

Other objects of the invention are a process for the manufacture of a chilled dairy dessert comprising solid pieces and a sauce.

### SUMMARY OF THE INVENTION

In a first aspect of the invention, there is provided a chilled dairy dessert comprising solid pieces, containing:
85 to 95 wt % of a dairy mousse comprising solid pieces,
5 to 15 wt % of a sauce,
wherein the total amount of components does not exceed 100%
wherein the sauce is laid as at least two threads within said dairy mousse comprising solid pieces.

Unless otherwise indicated, wt % (percent by weight) is understood as being expressed with respect to the total weight of the chilled dairy dessert.

The term “solid pieces” refers to any non-fluid inclusions that can be added in the dairy mousse and are easily perceived by the consumer as having a different texture than the mousse, in particular with respect to crunchiness. Solid pieces may be selected, for instance, from hard pieces such as dried or fresh nut pieces; dried or candied fruit pieces, or chocolate chips. Nut is understood according to the common usage of the word, and refers, for instance, to walnut, hazelnut, pecan, macadamia, almond, pistachio, Brazil nut, cashew, peanut, etc. Fruit is understood according to the common usage of the word and refers, for instance, to apple, pear, strawberry, raspberry and other berries, cherry, mango, banana, peach, apricot and others.

A “sauce” refers to any fluid, semi-liquid or viscous product which can be added to the dairy mousse, for example caramel sauce, chocolate sauce, vanilla sauce, coffee sauce, praliné sauce, mint sauce or any flavored sauce commonly used in desserts, or else a fruit coulis or a cream dessert.

The term “thread” refers to a rope or a strand of a product, which has a substantively constant cross-section, for instance a round cross-section, is preferably continuous, and which extends substantively over the whole height of the container. For instance, a thread extends over the whole height of a container and has a very small cross-section when compared to the cross-section of the container.

The dairy mousse is a neutral stable aerated food product obtained from a mixture containing a milk-based component and a stabilizer system.

In a second aspect of the invention, there is provided a process for preparing a chilled dairy dessert comprising solid inclusions and a sauce, comprising the steps of:
preparing a dairy mousse;
mixing the dairy mousse with a preparation containing solid pieces in order to obtain a mousse comprising solid pieces;
dosing the mousse comprising solid pieces into a suitable container, and
co-dosing a sauce together with the mousse comprising solid pieces, where the sauce is laid as at least two threads within said dairy mousse comprising solid pieces,
wherein the chilled dairy dessert comprises 85 to 95 wt % of a dairy mousse comprising solid pieces and 5 to 15 wt % of a sauce, the total amount of components does not exceed 100%.

The sauce is dosed as at least two threads within said dairy mousse comprising solid pieces.

The chilled dairy product according to the invention can be obtained, for example, by using a device for dosing a chilled dairy dessert including solid pieces and a sauce (a “co-dosing device”), into a container. The device comprises a dosing nozzle for co-dosing the mousse comprising solid pieces and the sauce.

The device and the nozzle which can be used to obtain the chilled dairy dessert according to the invention are fully described in the European patent application EP16174179.8 which is filed on the same day as the present patent application.

The dosing nozzle comprises a main outlet, and at least two peripheral outlets situated at a periphery of the main outlet. The dosing nozzle comprises a first channel adapted for providing the dairy mousse with solid pieces to the main outlet, and at least a second channel for providing the sauce to each peripheral outlet. The device comprises a support for holding the container to be filled from the nozzle. The device is configured so that the dosing nozzle and the support have a relative movement such that the nozzle follows a path around a central axis of the support.

Thanks to this device, the sauce may be distributed within the height of the final packaged product, for example helically, while the product into which the sauce is distributed is a dairy mousse with solid pieces which needs to be dosed through a larger outlet. For example, the device makes it possible to obtain vanilla mousse with pecan inclusions, with a caramel sauce helically distributed within the height of the container. Another final product may be, for example a chocolate mousse with macadamia inclusions and caramel sauce.

The sauce can be distributed within the height of the product, e.g. in two or more helical threads in the mousse comprising solid pieces.

The invention thus relates, in a preferred aspect, to a chilled dairy dessert as defined above, wherein said at least two threads of sauce are helical and extend over the height of said mousse.

In another embodiment, the threads may remain substantially parallel from the bottom to the top of the packaged product, except at the very top of the product where the two threads can meet. This particular feature at the top of the product can be obtained at the end of the dosing of the product into the container by quickly lifting the nozzle when the product delivery stops. Because the sauce sticks to the side of the product stream, which is narrowed by the lifting, the two sauce threads meet when the product delivery stops. The invention thus also relates to a chilled dairy dessert as defined above, wherein said at least two threads of sauce meet at the surface of said dairy mousse.

### BRIEF DESCRIPTION OF THE FIGURES

FIG. 1 is a an illustrative view of a device for dosing a chilled dairy dessert with solid pieces into a container, with a sauce distributed within the height of the packaged product;

FIG. 2 is a schematic representation of the outlet of a nozzle seen from below;

FIG. 3 is a schematic view in cross-section of the nozzle of FIG. 2;

FIG. 4 is a schematic view of the device of FIG. 1 in use;

FIG. 5 is a schematic view of a a packaged chilled dairy dessert with solid pieces and a sauce that may be obtained with this;

FIG. 6 is a schematic principle representation of a system comprising two devices, each with a dosing nozzle.

### DETAILED DESCRIPTION

In order to meet the consumer expectations, it was found by the inventors that mousse texture on the one hand, size, crunchiness and distribution of solid inclusions on the other hand, as well as the quantity and texture of the sauce were important characteristics. Also, from a sensory point of view, they found that the solid inclusions should remain crunchy, visually perceivable and of pleasant taste. Thus the inventors set themselves to create a dairy dessert which may exhibit at least three different textures: the softness of a dairy mousse, the crunchiness of rather large solid pieces such as nuts, and the thickness of a sauce. The inventors found it difficult to develop a process where the resulting products are consistent throughout product cycles, and which remains stable during shelf life.

The invention thus relates to a chilled dairy dessert containing solid pieces, containing:
85 to 95 wt % of a dairy mousse comprising solid pieces,
5 to 15 wt % of a sauce,
wherein the total amount of components does not exceed 100%,
wherein the sauce is laid as at least two threads within said dairy mousse comprising solid pieces.

Advantageously, the chilled dairy dessert according to the invention has a shelf-life of up to 28 days, preferably up to 35 days, at a temperature of 4° C. to 8° C.

The dairy mousse component is a stable aerated food product obtained from a mixture of a milk-based component and a stabilizer system. “Aerated” (or “whipped”) refers to the incorporation of a gas into a food material. For purposes herein, the gas is not particularly limited, and may be air, nitrogen, carbon dioxide, nitrous oxide, gas combinations thereof.

Any standard equipment used in the chilled dairy industry can be used for aeration, such as, for example, an equipment of the type MONDOMIX, AEROMIX or HPW (High Pressure Whipping System).

By “milk-based component” is meant at least one component selected from whole milk, skimmed milk or partially skimmed milk, optionally reconstituted from milk powder, dairy cream, anhydrous milk fat, milk protein powder, and their mixtures.

The stabilizer system provides stability to the dairy mousse, thus helping in maintaining its aerated structure, and can be selected from the group consisting of agar-agar, alginates, carrageenan, caseinates, gelatine, gellan, modified and native starches and combinations thereof. The stabilizer system may be present in an amount of up to 5 wt % in total (2 wt % without starch) with respect to the dairy mousse.

The dairy mousse component may also contain at least one emulsifier, such as, for example, mono- and di-glycerides of fatty acids, lactic acid esters of mono- and di-glyceride, sucroesters, polyglycerol esters of fatty acids and combinations thereof, in an amount of up to 1.5 wt % with respect to the dairy mousse.

The dairy mousse component may also contain usual ingredients, such as a sugar ingredient, for instance a natural sugar, or flavoring agents. Examples of natural sugars are saccharose, all types of syrup glucose or syrup fructose or natural extracts like stevia or rebaudioside A, and their combinations. The sugar ingredient can also comprise any sweetener, such as an artificial sweetener. Examples of artificial sweeteners are aspartame, acesulfame, sucralose, saccharin, neotame, and their combinations. Mixtures of natural sugars and artificial sweeteners are also appropriate.

Preferably, the dairy mousse component is, for example, a chocolate mousse, containing cocoa powder and/or chocolate, or a vanilla mousse, containing vanilla flavour or vanilla extract, or a caramel mousse containing caramel. Other flavours can be considered for the preparation of the mousse.

“Overrun” refers to the increase in volume of the dairy mousse and is also referred to as a foaming capacity. It is calculated according to the following equation:

% overrun=(weight of the food mix before aeration−weight of same volume of the mousse after aeration)/(weight of same volume of mousse after aeration)×100. It is reported as a percentage value.

Preferably, the dairy mousse component has an overrun of 80% to 140%, preferably around 120%. The chilled dairy dessert containing solid pieces and a sauce, has preferably an overrun of 60% to 120%, preferably 80 to 110%, most preferably 90 to 100%.

The dairy mousse component has preferably a neutral pH. “Neutral pH” as used herein means a pH value in the range of 6.5 to 7.0. If needed, pH adjustment can be carried out by usual means, such as addition of a food grade acid or base.

The amount of solid pieces can be, in particular, 2 to 15 wt %, preferably 4 to 10 wt % of the chilled dairy dessert.

Preferably, a solid piece used in the invention, in particular a nut piece or a fruit piece, may have an average diameter of 6 to 13 mm, preferably 8 to 12 mm. The maximum size of the solid pieces (e.g nuts) may be significantly higher than the average size, and may, for example, be up to 18 mm. The size of nut or fruit pieces may vary slightly during production of the preparation containing solid pieces due to water take-up. The average size is based on the size distribution in a standard sieving equipment.

As already mentioned, solid pieces may be selected, for instance, from hard pieces such as dried or fresh nut pieces; dried or candied fruit pieces, or chocolate chips.

Nut is understood according to the common usage of the term, and refers, for instance, to walnut, hazelnut, pecan, macadamia, almond, pistachio, Brazil nuts, cashew, peanut, etc.

Fruit is understood according to the common usage of the word and refers, for instance, to apple, pear, strawberry, raspberry and other berries, cherry, mango, banana, peach, apricot and others.

Sauces can be, for example, a chocolate, vanilla, caramel, coffee, mint, praliné or any flavored sauce commonly used in desserts, or else a fruit coulis, a fruit puree or a cream dessert.

The sauce has, preferably, a viscosity of 120 000 to 180 000 mPa·s. Viscosity can be measured, for example, with a Brookfield viscometer, at a temperature of 8° C., a rotation speed of 5 rpm and a cross-shaped probe reference T bar 93.

Preferably, the sauce can have a dry matter content of about 30 to 55% and a Brix degree of about 30 to 55.

In particular, the amount of sauce in the chilled dairy dessert can be 5 to 15 wt %, preferably 8 to 10 wt %.

In a second aspect of the invention, there is provided a process for preparing a chilled dairy dessert comprising soft and solid inclusions, comprising the steps of:
preparing a dairy mousse;
mixing the dairy mousse with a preparation containing solid pieces in order to obtain a mousse comprising solid pieces;
dosing the mousse comprising solid pieces into a suitable container, and
co-dosing a sauce together with the mousse comprising solid pieces, where the sauce is laid as at least two threads within said dairy mousse comprising solid pieces,
wherein the chilled dairy dessert comprises 85 to 95 wt % of a dairy mousse comprising solid pieces and 5 to 15 wt % of a sauce, the total amount of components does not exceed 100%.

The dairy mousse can be prepared in a usual way, for instance by a process comprising the following steps:
mixing the milk base components and optional other components of the dairy mousse in dry or liquid form (hot or cold powdering),
performing a powder hydrating step, where needed,
adjusting the pH, where needed,
pre-heating the mixture to 55-70° C.,
homogenizing the mixture, for instance under a pressure of 0 to 200 bar (0 to 200.10⁵ Pa),
submitting said mixture to an UHT heat treatment,
cooling the mixture to 4-20° C., and
whipping said mixture to obtain a dairy mousse having an overrun of 80% to 140%, preferably around 120%.

According to the invention, the dairy mousse is then mixed with 5 to 25 wt % of a preparation containing solid pieces, preferably in a dynamic mixer, and then provided to an intermediate reservoir or tank. Preferably, the storage time of the mixture is as short as possible, to avoid that the mousse structure breaks. At the outlet of the dynamic mixer, the mousse comprises homogenously distributed solid pieces.

The step of co-dosing the sauce is carried out by providing the sauce through an independent circuit and co-dosing the sauce via a dosing nozzle comprising separate outlets for the mousse comprising solid pieces, on the one hand, and the sauce, on the other hand. The sauce and the mousse comprising solid pieces are metered into a suitable container. Storage of the filled container can be carried out at a positive temperature of 0 to 8° C., preferably about 4° C.

The preparation containing solid pieces helps providing appropriate amounts and adequate repartition of the solid pieces in the dairy mousse, in order to provide the desired texture in the final product. It also helps to stabilize the solid inclusions from a microbiological standpoint. Indeed, it is easier to sterilize or pasteurize the solid pieces. in an aqueous medium.

The preparation containing solid pieces may comprise 20-60 wt % of solid pieces in 40-80 wt % of a liquid carrier, before mixing into the dairy mousse. This preparation can be UHT treated to reduce the bacterial load of the solid pieces, especially when solid pieces are nut pieces. For instance, the liquid carrier comprises water, sugar and a stabilizer system. Preferably, the preparation containing solid pieces comprises 20-45 wt % of solid pieces, 40-55 wt % of water, 15-25 wt % of sugar, and 1-2 wt % of a stabilizer system. The stabilizer system comprises hydrocolloids, such as modified starch, xanthan gum and/or guar gum. The stabilizer system may also comprise an emulsifier, such as monoglycerides. The dry matter content of the preparation containing solid pieces ranges from 45 to 60%.

It is desirable that said preparation contains a high proportion of solid piece. The high content of solid pieces in the preparation is needed to incorporate a maximum of pieces in the final dessert product, without destroying the texture and the organoleptic properties of the dairy product, especially considering it is a mousse. Preferably, the texture of the liquid carrier is compatible with that of the dairy mousse. This allows mixing the preparation containing solid pieces with the mousse, without breaking the mousse, or with a minimal breaking of the mousse.

Preferably, the final dessert product contains from 2 to 15 wt % of solid pieces, preferably from 4 to 10 wt %. The amount of solid pieces in the final dessert product can be determined by sieving. Sieving is performed according to a standard laboratory method using a sieving equipment, over a 0.5 mm sieve. A predetermined weight of the final dessert is poured onto the automatic sieve, rinsed with water for 2 min before sieving. The vibrations are applied for 1 min to remove the excess water from the sieve. The weight % of solid pieces is determined by weighing the pieces retained in the 0.5 mm sieve.

The device for dosing into a container a chilled dairy dessert including solid pieces and a sauce (“co-dosing device”) comprises a dosing nozzle. The dosing nozzle comprises a main outlet, and at least two peripheral outlets situated at a periphery of the main outlet. The dosing nozzle comprises a first channel adapted for providing the dairy mousse with solid pieces to the main outlet, and at least a second channel for providing the sauce to each peripheral outlet. The device comprises a support for holding the container to be filled from the nozzle. The device is configured so that the dosing nozzle and the support have a relative movement such that the nozzle follows a path around a central axis of the support.

Thanks to this device, the sauce may be distributed within the height of the final packaged product, for example helically, while the product into which the sauce is distributed is a dairy mousse with solid pieces which needs to be dosed through a larger outlet. For example, the device makes it possible to obtain vanilla mousse with pecan inclusions packaged in a container, with a caramel sauce helically distributed within the height of the container. Another final product may be, for example a chocolate mousse with macadamia inclusions and caramel sauce.

The path around the central axis of the support may be circular or substantially circular, or helical, or substantially helical.

To obtain the relative movement between the nozzle and the support, the nozzle may be movable, while the support is fixed. In another variant embodiment, the support may be rotatable, while the nozzle is fixed. The nozzle and the support may be both movable. Preferably, the support may be rotatable while the nozzle is movable along a vertical axis.

The main outlet may have an area equal or superior to five times the area of each peripheral outlet, preferably comprised between five and twenty times the area of each peripheral outlet and more preferably between five and twelve times the area of each peripheral outlet.

In embodiments, the main outlet may be substantially circular with a diameter comprised between 10 mm and 30 mm, such as between 15 mm and 25 mm.

For example each of the peripheral outlets may have an area comprised between 8 mm² and 20 mm².

Preferably, the nozzle comprises exactly two peripheral outlets. In such a case, the nozzle extending along a main axis, an arc defined between the two peripheral outlets may subtend an angle at the main axis comprised between 30° and 90° and preferably between 45° and 60°.

In an embodiment wherein the nozzle extends along a nozzle axis, the nozzle may be rotatably adjustable around said nozzle axis (N).

The device for co-dosing a dairy mousse with solid pieces and a sauce, is part of a manufacturing equipment which further comprises:
a first line for providing the dairy mousse with solid pieces to said device successively comprising a pump for pumping a dairy mousse in the first circuit, a dynamic mixer for mixing solid pieces into the dairy mousse, at least one dosing piston adapted to feed the device with a dairy mousse with solid pieces; and
a second line for providing the sauce to said device.

The manufacturing equipment further comprises, between the pump and the dynamic mixer, a whipper for aerating a dairy composition and preparing the dairy mousse.

According to an embodiment, the system may comprise four to ten devices for filling a container with a dairy mousse with solid pieces and a sauce.

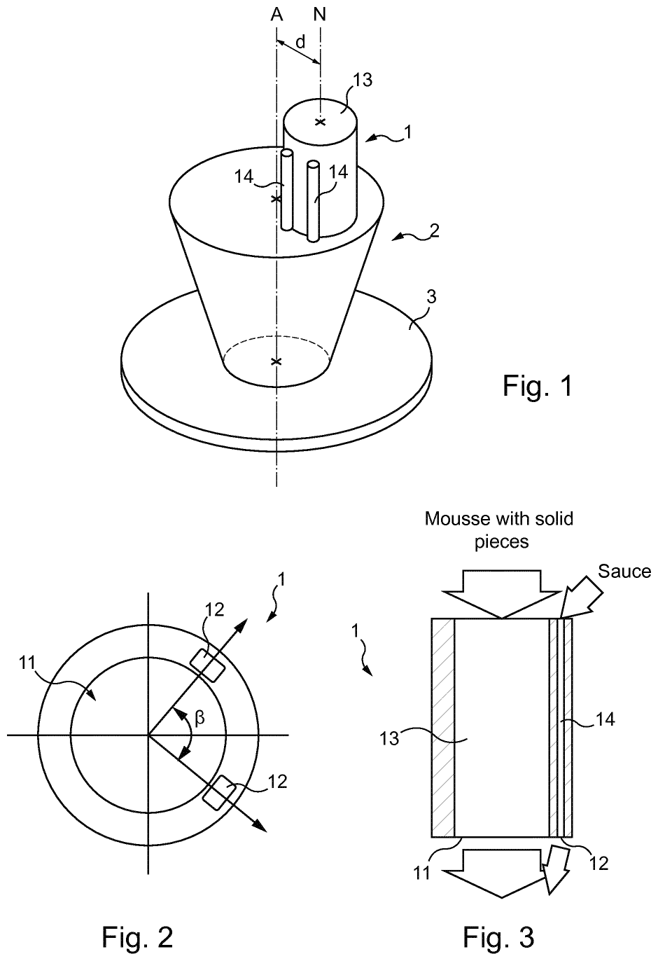

FIG. 1 illustrates a co-dosing device. The device of FIG. 1 comprises a co-dosing nozzle 1, some details of which are shown schematically in FIG. 2 and FIG. 3.

The dosing nozzle 1 comprises a main outlet 11. The main outlet 11 is provided with a dairy mousse comprising solid pieces, via a first channel 13. The main outlet 11 and the first channel 13 have a sufficient size (e.g. a sufficient diameter) to avoid any risk of obstruction by solid pieces comprised in the dairy mousse.

For example, the main outlet 11 (or main hole of the nozzle) and the first channel 13 may be configured to have a diameter or transverse measurement of at least twice the average size of the solid pieces included in the dairy mousse to deliver. If the main outlet 11 or the cross section of the first channel 13 is not circular, it may be sized to comprise a circle (inscribed circle) having a diameter of at least at least twice the average size of the solid pieces included in the dairy mousse to deliver.

For the above cited solid pieces, a main outlet having a diameter (or an inscribed circle having a diameter) of 6 mm to 30 mm, for example 18 mm, 20 mm or 25 mm, is convenient.

The nozzle comprises at least two peripheral outlets 12 situated at a periphery of the main outlet. The peripheral outlets 12 (or peripheral holes of the nozzle) are provided with a sauce or sauces via second channels 14.

The peripheral outlets 12 are situated in the vicinity of the main outlet 13, preferably as close as possible to said main outlet 11. This makes it possible for the sauce to adhere to the side of the stream of dairy mousse when it is metered or dosed into the container 2. This is in particular the case with a mousse, i.e. an aerated product, which may be delivered under pressure and expands when it is delivered by the nozzle.

The peripheral outlets may have a small size and the second channels 14 a corresponding small cross-section, as the sauce is a product without solid pieces, contrary to the mousse with solid pieces. In addition, a small cross section makes it possible to form threads of sauce in the final product, which may be the desired appearance for said final product.

In the embodiment represented in FIGS. 1-5, the nozzle comprises two peripheral outlets. More peripheral outlets 12, for example three, four, five, or six outlets may be provided at the periphery of the main outlet 11. Preferably, the nozzle comprises two, three or four peripheral outlets 12. Advantageously, the peripheral outlets 12 are distributed around one half of the periphery of the main outlet 11 (e.g. in the same half cross-section of a cylindrical nozzle). An angle β of 30° to 90° (relative to a nozzle axis N) may be provided between two peripheral outlets. The angle β, and the distance of the peripheral outlets 12 relative to the central axis A may be adapted to the coefficient of expansion of the mousse when it flows out of the nozzle.

The same sauce or different sauces may be provided to each peripheral outlet or groups of peripheral outlets. When a single sauce is provided, it may be distributed for instance through a common channel which splits into as many second channels 14 as needed. If several sauces are provided, second channels 14 of the nozzle are fed from separate sources.

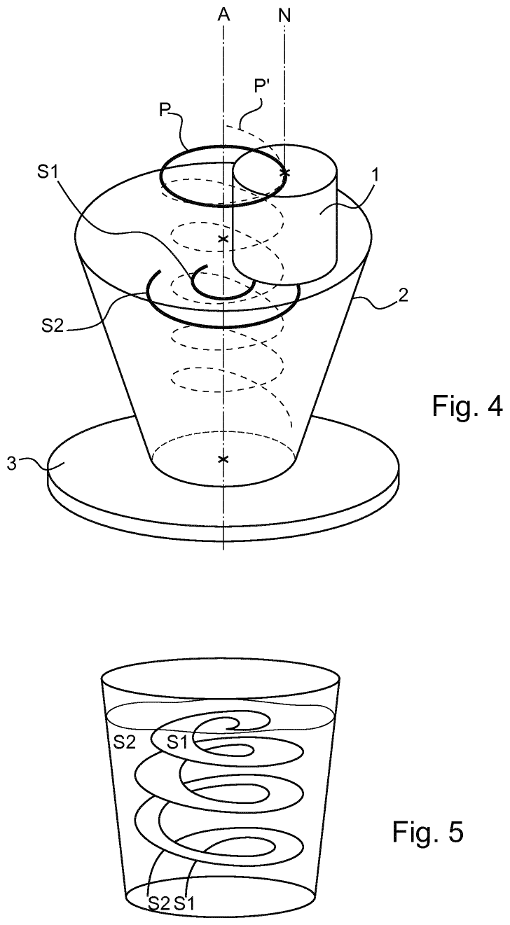

The device comprises a support 3 for holding a container or receptacle to be filled from the nozzle with the mousse with solid pieces and a sauce. The device is configured so that the dosing nozzle 1 moves, relative to the support 3, on a path P around a central axis of said support, as shown in FIG. 4. A relative movement between the nozzle 1 and the support 3 (and so the container 4) is thus provided when the device is used to fill the container 2.

In fact, two relative movements may be provided between the nozzle 1 and the support 3. First, the nozzle may be moved from bottom to top while the container is filled (or the support may be moved from the top to the bottom). This is well known in the field of dosing technologies.

Second, there is provided a horizontal relative movement between the nozzle 1 and the support 3, around a central axis A of said support 3 (i.e. around a central axis of the container). The central axis A is a vertical axis. The combination of the vertical movement and the horizontal relative movement defines a path of the nozzle around the central axis A.

In the embodiment represented in FIG. 4, the path P is circular around the central axis A, and the relative movement is caused by a rotation of the support 3 around said central axis A, while the nozzle is fixed. Because the nozzle is offset from the central axis A (in the represented embodiment, the nozzle extends along a nozzle axis N parallel with the central axis A, at a distance d from said central axis A), the nozzle describes a circle around the central axis A which is also the rotation axis of the support 3.

There is also represented in FIG. 4 an alternative path P′ which is helical, said path being obtained by the combination of a circular horizontal relative movement of the nozzle 1 around the central axis A and of a vertical relative movement between the nozzle 1 and the support 3.

In another embodiment, the support may be fixed while the nozzle is mobile on the desired path P.

When the support is mobile and the nozzle fixed, the support may have a combined movement of a rotation and a horizontal and/or vertical translation to define a non-circular path.

Of course the means for generating relative horizontal and vertical movements between the nozzle 1 and the support 3 may be the same or not, in other words, the support may fixed or mobile horizontally and vertically, the nozzle may be fixed or mobile horizontally and vertically, and many relative movements, and thus many paths of the nozzle around the central axis A, may be obtained by combination of the movements of the nozzle and/or of the support.

When the device is used, the nozzle is rotationally fixed around the nozzle axis N. However, in some embodiments of the invention, the device is configured so that a rotational adjustment of the nozzle may be performed. The position of the nozzle may in these embodiments be adjusted, mainly for adjusting the position of the peripheral outlets of the nozzle relative to the rest of the device, notably the distance of the peripheral outlets 2 to the central axis A. In the represented embodiment, a rotational adjustment of the nozzle makes it possible to adjust the distance of the peripheral nozzle to the central axis A, and also, at the same time, to modify the distance between the two sauce threads S1, S2 formed in the final packaged product.

When the sauce and the dairy mousse with solid pieces are introduced at a distance from the central axis A, while the nozzle describes a path around said central axis 1, the sauce forms threads included in the volume (or “mass”) of mousse with solid pieces. The sauce threads S1, S2, may be distributed in the final product as shown in FIG. 5. The sauce threads S1, S2 have the form of two parallel helical threads. For example, the two threads situated respectively at about one third and two thirds of the diameter of a container into which the product is delivered.

The threads may remain substantially parallel from the bottom to the top of the packaged product, except at the very top of the product where the two threads S1, S2 can meet. This particular feature at the top of the product can be obtained at the end of the dosing of the product into the container by quickly lifting the nozzle when the product delivery stops. Because the sauce sticks to the side of the product stream, which is narrowed by the lifting, the two sauce threads S1, S2 meets when the product delivery stops.

A consumer can easily distinguish the sauce from the dairy mousse. The sauce and the dairy mousse may have different color, or texture, or viscosity, or overrun. Also they have different viscosities and overrun, which provides a different mouthfeel.

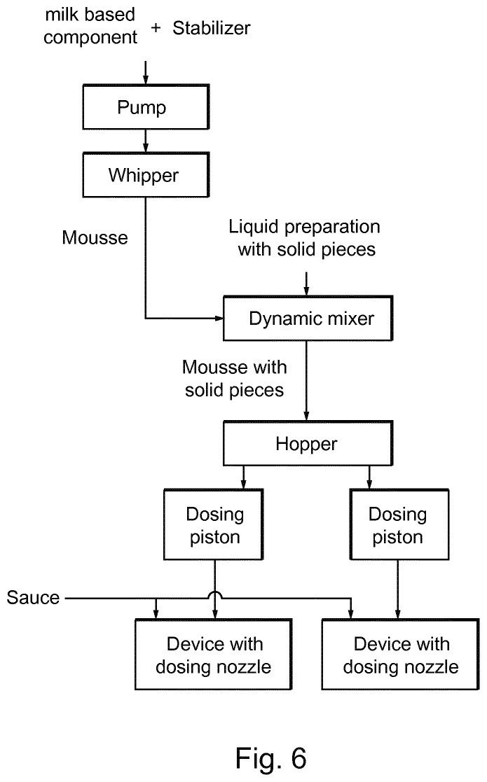

FIG. 6 represents the operating principles of a system according to an aspect of the invention. In this embodiment, the system comprises two devices each with a dosing nozzle.

The system comprises a co-dosing device according to an embodiment of the invention, referred to in FIG. 6 as a “device with dosing nozzle”. This device makes it possible to dose a dairy mousse with solid pieces and a sauce distributed within the height of the product, in particular in the form of two or more helical threads.

The sauce is provided via a dedicated line to the device. As mentioned, the dairy mousse with solid pieces may be produced and provided in the following manner.

A base product is provided. It may be for example a milk-based component with a stabilizer. A pump feeds a whipper with dairy composition, where the dairy composition is whipped and aerated, i.e. mixed with a gas such as air to form a dairy mousse, e.g. a dairy mousse component.

The mousse is then provided to a dynamic mixer where it is mixed with the desired amount of solid pieces such as nuts.

The solid pieces may be provided in a liquid preparation containing solid pieces.

At the outlet of the dynamic mixer, the mousse comprises homogenously distributed solid pieces, and thus forms a dairy mousse with solid pieces.

The dairy mousse with solid pieces is provided to a tank or hopper. The hopper forms an intermediate reservoir which is able to feed one or several devices for filling containers with the dairy mousse with solid pieces. The hopper has a volume which is sufficient to feed the devices for filling containers without the risk of a product shortage. For example, each dosing piston has a dosing volume (which may be the same for each dosing piston), and the intermediate reservoir (e.g. provided by the hopper) has a volume greater than the sum of the dosing volumes of the dosing pistons of the system.

In a particular embodiment, the dynamic mixer and the hopper or intermediate reservoir may be formed by a single apparatus. In other words, the dynamic mixer may be located in the hopper.

The dairy mousse with solid pieces may be pumped with dosing piston pumps (typically one dosing piston for each device).

In particular, the dairy mousse with solid pieces is provided to the first channel 13 and main outlet 11 of the nozzle 1 of each device. A given quantity of the dairy mousse with solid pieces flows from the nozzle each time the dosing piston is actuated. This quantity may advantageously correspond to the quantity desired in each container to be filled.

Advantageously, the transport pipes between the dynamic mixer and the co-dosing device may have a constant inside diameter. Generally speaking, any obstacle, recess or unrounded corner should be avoided in said transport pipes to avoid obstruction by solid pieces contained in the transported dairy mousse.

The sauce is provided to the co-dosing device via an independent, dedicated line, and is provided to the second channels 14 and the peripheral outlets of the nozzle. Many types of pumps may be contemplated for the delivery of the sauce.

The delivery of the sauce has to be synchronized with the delivery of dairy mousse with solid pieces product into the container. The delivery of the sauce advantageously starts at the same time as the delivery of dairy mousse with solid pieces by the nozzle 1. The delivery of the sauce advantageously stops at the end or shortly after the end of the delivery of dairy mousse with the nozzle 1. Other synchronization schemes may be contemplated. For example, the delivery of the sauce may be started and stopped several times when filling a single container, for providing the final packaged product with a sauce.

The device, system and method provided in the invention thus make it possible to produce a packaged product comprising a dairy mousse with solid pieces and a sauce distributed within the height of the packaged product with a desired pattern, for example in the form of several threads within the dairy mousse.

Any reference to prior art documents in this specification is not to be considered an admission that such prior art is widely known or forms part of the common general knowledge in the field.

As used in this specification, the words “comprises”, “comprising”, and similar words, are not to be interpreted in an exclusive or exhaustive sense. In other words, they are intended to mean “including”, but not limited to.

The invention is further described with reference to the following examples. It will be appreciated that the invention as claimed is not intended to be limited in any way by these examples.

### EXAMPLE

The products were prepared by using the following protocol:
1) Preparing a standard dairy mousse having an overrun of 100-130% by mixing the mousse ingredients to a standardized composition, homogenizing, UHT treating for instance at 130° C. for 40 s or 140° C. 10 s, cooling, and whipping.
2) Mixing the mousse with 5-25 wt % of a preparation with nut pieces in a dynamix mixer
3) Pumping to an intermediate tank
4) Co-dosing the mousse containing solid pieces with a sterilized sauce: 5-15% sauce

| | | | | | % |
|---|---|---|---|---|---|
| | | | % | | Pieces |
| Exam- | | % | preparation | % | (after |
| ple | Composition | Mousse | with pieces | Sauce | sieving) |
| 1 | Vanilla mousse with | 80 | 12 | 8 | 4.9 |
| | pecan nut pieces, | | | | |
| | with a caramel sauce | | | | |
| 2 | Caramel mousse with | 80 | 12 | 8 | 4.9 |
| | pecan nut pieces, | | | | |
| | with a chocolate sauce | | | | |
| 3 | Chocolate mousse with | 79 | 11 | 10 | 5.2 |
| | macadamia nut pieces, | | | | |
| | with a caramel sauce | | | | |
| 4 | Milk chocolate mousse | 81 | 9 | 10 | 4.0 |
| | with hazelnut pieces, | | | | |
| | with a caramel sauce | | | | |

The chilled dairy dessert of examples 1 to 4 had an overrun of between 80% and 100%. The viscosity of the sauces was about 140000 mPa·s. The average diameter of pieces was about 8 mm, taking into account water take-up during production of the preparation with pieces and of the chilled dairy dessert. The preparation with solid pieces had a dry matter content of about 48 to 55%.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

1. A chilled dairy dessert comprising solid pieces, containing:
85 to 95 wt % of a dairy mousse comprising solid pieces;
5 to 15 wt % of a sauce;
the total amount of components does not exceed 100%; and
wherein the sauce is laid as at least two threads within said dairy mousse comprising solid pieces.

2. A chilled dairy dessert according to claim 1, wherein the amount of solid pieces is from 2 to 15 wt % of the dessert.

3. A chilled dairy dessert according to claim 1, wherein the sauce is selected from the group consisting of chocolate, vanilla, caramel, coffee, mint, praliné any flavored sauce commonly used in desserts, a fruit coulis, a fruit puree and a cream dessert.

4. A chilled dairy dessert according to claim 1, wherein the sauce has a viscosity of 120000 to 180000 mPa·s, as measured with a Brookfield viscometer, at a temperature of 8° C., a rotation speed of 5 rpm and a cross-shaped probe reference T bar 93.

5. A chilled dairy dessert according to claim 1, wherein the solid pieces are selected from the group consisting of hard food pieces, dried pieces, candied fruit pieces, and chocolate chips.

6. A chilled dairy dessert according to claim 1, wherein the average diameter of the solid pieces ranges from 6 to 13 mm.

7. A chilled dairy dessert according to claim 1, wherein the amount of sauce in the chilled dairy dessert ranges from 8 to 10 wt %.

8. A chilled dairy dessert according to claim 1, wherein at least two threads of sauce are helical and extend over the height of said dairy mousse.

9. A chilled dairy dessert according to claim 1, wherein at least two threads of sauce meet at the surface of the dairy mousse.

10. A chilled dairy dessert according to claim 1, which has an overrun of 60 to 120%.

11. A process for preparing a chilled dairy dessert comprising solid pieces, comprising the steps of:
preparing a dairy mousse;
mixing the dairy mousse with a preparation containing solid pieces in order to obtain a mousse comprising solid pieces;
dosing the mousse comprising solid pieces into a suitable container; and
co-dosing a sauce together with the mousse comprising solid pieces, where the sauce is laid as at least two threads within said dairy mousse comprising solid pieces,
wherein the chilled dairy dessert comprises 85 to 95 wt % of a dairy mousse comprising solid pieces and 5 to 15 wt % of a sauce, the total amount of components does not exceed 100%.

12. The process of claim 11, wherein the dairy mousse is mixed with 5 to 25 wt % of a preparation containing solid pieces in a dynamic mixer.

13. The process of claim 11, wherein the preparation containing solid pieces comprises 20-60 wt % of solid pieces in 40-80 wt % of a liquid carrier.

14. The process of claim 11, wherein the preparation containing solid pieces comprises 20-45 wt % of solid pieces, 40-55 wt % of water, 15-25 wt % of sugar, and 1-2 wt % of a stabilizer system.
